(19) United States
(12) Patent Application Publication
(10) Pub. No.: US 2015/0323156 A1
(43) Pub. Date: Nov. 12, 2015

(54) LIGHT SOURCE DEVICE

(71) Applicant: HITACHI MAXELL, LTD., Ibaraki-shi, Osaka (JP)

(72) Inventors: Kohei MIYOSHI, Ibaraki (JP); Masayuki FUKUI, Ibaraki (JP); Kei ADACHI, Ibaraki (JP); Chohei ONO, Ibaraki (JP)

(73) Assignee: Hitachi Maxell, Ltd., Ibaraki-shi, Osaka (JP)

(21) Appl. No.: 14/653,709

(22) PCT Filed: Feb. 27, 2013
(86) PCT No.: PCT/JP2013/055253

§ 371 Date: Jun. 18, 2015

(51) Int. Cl. F21V 13/08; F21V 13/14; F21K 99/00; F21V 14/08

(52) U.S. Cl. CPC F21V 13/08; F21V 14/08; F21V 13/14; F21K 9/56

(57) ABSTRACT

A light source device includes: an excitation light source which generates excitation light; a phosphor wheel having a phosphor which is excited by the excitation light to generate fluorescent light; and a mirror which guides excitation light from the excitation light source to the phosphor wheel to emit the fluorescent light from the phosphor wheel as illumination light. The phosphor wheel further includes a diffusion/reflection portion which diffuses and reflects incident excitation light, and the mirror has a first region which reflects the excitation light and transmits the fluorescent light and a second region which transmits the fluorescent light and diffused excitation light. In the mirror, the fluorescent light transmitted through the first region and the fluorescent light and the diffused excitation light transmitted through the second region are used as illumination light.

### TECHNICAL FIELD

The present invention relates to a light source device.

### BACKGROUND ART

In this technical field, a light source device which converts excitation light emitted from a fixed light source into visible light with a phosphor to efficiently emit light is provided. PTL 1 discloses a configuration which irradiates excitation light (blue laser light) emitted from a light source on a disk-like (phosphor wheel) on which a phosphor is formed to cause the disk-like wheel to emit a plurality of fluorescent lights (red light and green lights) and uses the fluorescent lights as illumination light.

### CITATION LIST

### Patent Literature

PTL 1: Japanese Patent Application Laid-Open No. 2011-13313

### SUMMARY OF INVENTION

### Technical Problem

According to PTL 1, excitation light transmitted through a transparent portion of the phosphor wheel and fluorescent light generated by the phosphor wheel are used as illumination light. However, both the lights are emitted in opposite directions with respect to the phosphor wheel. Thus, the number of optical components for combining the lights to each other increases to disadvantageously increase the light source device in size. An optical loss is caused by the plurality of optical components arranged in an optical system to disadvantageously decrease efficiency of utilizing light (illumination light intensity).

It is an object of the present invention to provide a light source device which causes a phosphor wheel to emit diffused excitation light and fluorescent light to the same side of the phosphor wheel, collects both the lights with a simple configuration, and uses the collected light as illumination light.

### Solution to Problems

In order to solve the above problem, one of desirable aspects of the present invention is as follows.

The light source device includes an excitation light source which generates excitation light, a phosphor wheel having a phosphor which is excited by the excitation light from the excitation light source to generate fluorescent light, and a mirror which guides the excitation light from the excitation light source to the phosphor wheel and emits the fluorescent light from the phosphor wheel as illumination light, the phosphor wheel further including a diffusion/reflection portion which diffuses and reflects incident excitation light, and the mirror having a first region which reflects the excitation light and transmits the fluorescent light and a second region which transmits the fluorescent light and the diffused excitation light diffused and reflected by the diffusion/reflection portion.

### Advantageous Effects of Invention

According to the present invention, since the phosphor wheel is caused to emit the diffused excitation light and the fluorescent light to the same side, a small-sized light source device can be achieved without decreasing an illumination light intensity.

### BRIEF DESCRIPTION OF DRAWINGS

FIG. 1 is a block diagram of a light source device according to a first embodiment.

FIGS. 2A and 2B are diagrams showing concrete examples of a mirror 4.

FIG. 3 is a diagram showing an example of the spectral characteristics of the mirror 4.

FIG. 4 is a diagram showing a concrete example of a phosphor wheel 1.

FIG. 5 is a diagram showing the degree of diffusion of emitted light from the phosphor wheel 1.

FIG. 6 is a block diagram of a light source device according to a second embodiment.

FIG. 7 is a block diagram of an optical system of a projection type video display device according to a third embodiment.

FIG. 8 is a block diagram of an optical system of a projection type video display device according to a fourth embodiment.

### DESCRIPTION OF EMBODIMENTS

Embodiment of the present invention will be described below with reference to the accompanying drawings.

### First Embodiment

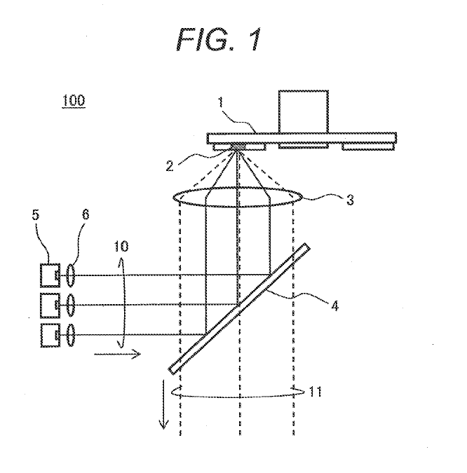

FIG. 1 is a block diagram of a light source device according to a first embodiment. A light source device 100 includes, as main constituent elements, an excitation light source 5, a mirror 4, and a phosphor wheel 1. As the excitation light source 5, at least one solid-state light-emitting element such as a laser light-emitting element is disposed to emit, for example, blue laser light as excitation light. Excitation light 10 (indicated by a solid line) emitted from the excitation light source 5 is converted into nearly parallel light rays with a collimate lens 6, the nearly parallel light rays are incident on the mirror 4.

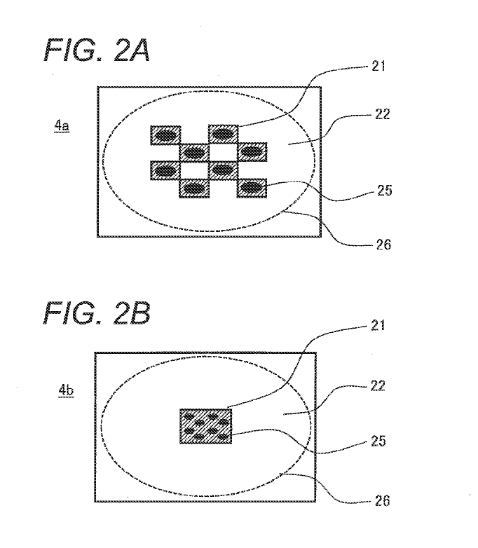

The mirror 4 is configured by two regions. The first region is a dichroic coat region 21 characterized by reflection of a wavelength band of excitation light (blue) and transmission of wavelength bands (red, yellow, and green) fluorescent light. The second region is a wide-wavelength transmission region 22 which transmits both the wavelength bands of excitation light and fluorescent light. The first region has an area smaller than that of the second region. A concrete example of the mirror 4 will be described with reference to FIGS. 2A and 2B. The excitation light 10 which is incident from the excitation light source 5 is reflected by the dichroic coat region 21 of the mirror 4, collected by a condenser lens 3, and incident on the phosphor wheel 1.

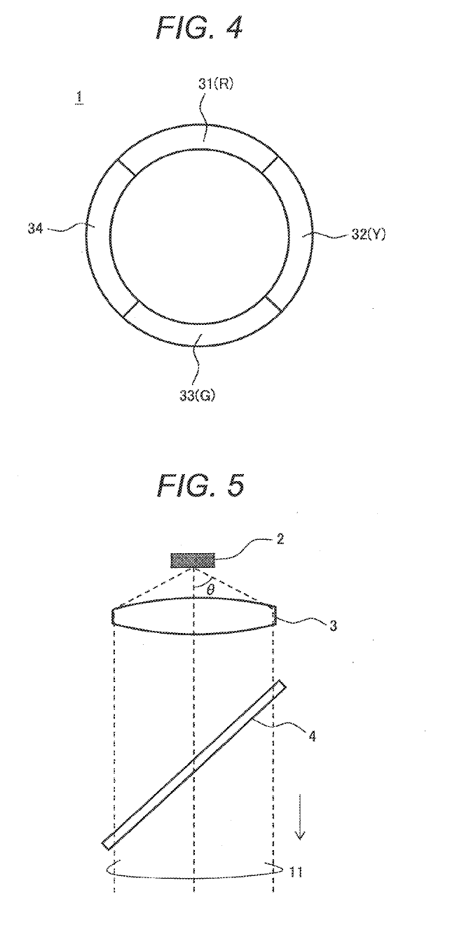

On the rotatable phosphor wheel 1, a phosphor 2 which is excited with the excitation light 10 to generate fluorescent light of a predetermined color is formed. For example, in order to generate fluorescent lights of three colors, e.g., red, yellow, and green, a disk surface is circumferentially divided into a plurality of regions, and red, yellow, and green phosphors are formed on the regions, respectively. Furthermore, on the disk surface, a diffusion/reflection portion which diffuses and reflects the excitation light 10 is formed. A concrete example of the phosphor wheel 1 will be described with reference to FIG. 4. When the phosphor wheel 1 receives the excitation light 10, fluorescent lights of three colors, i.e., red, yellow, and green are generated from the phosphors 2 of the phosphor wheel 1, diffused excitation lights are generated from the diffusion/reflection portion, all the diffused excitation lights are converted into nearly parallel light rays with the condenser lens 3, and the nearly parallel light rays are incident on the mirror 4.

The fluorescent light being incident on the mirror 4 is transmitted through both the dichroic coat region 21 and the wide-wavelength transmission region 22 in the mirror 4. On the other hand, the diffused excitation lights being incident on the mirror 4 are reflected by the dichroic coat region 21 but transmitted through the wide-wavelength transmission region 22. As a result, all the fluorescent lights and most of the diffused excitation lights are emitted as illumination light 11 downward in the drawing.

With this configuration, both the fluorescent lights and the diffused excitation lights generated by the phosphor wheel 1 are emitted from the phosphor wheel 1 to the same side (lower side in the drawing), and most of the fluorescent lights and the diffused excitation lights are transmitted through the mirror 4 and serve as illumination light. Thus, an additional optical system to combine both the fluorescent light and the excitation light need not be disposed, and a reduction in size of the device can be achieved.

FIG. 2 are diagrams showing two concrete examples of the mirror 4.

In FIG. 2A, at a central portion of the incident surface of the mirror 4a, the dichroic coat regions 21 (hatched portions) serving as the first region are divisionally formed in a checked pattern, and the remaining portions are used as wide-wavelength transmission regions 22 (white portions) serving as the second regions. The dichroic coat regions 21 are characterized by reflection of the wavelength band of excitation light (blue) and transmission of the wavelength bands (red, yellow, and green) of fluorescent light. The wide-wavelength transmission regions 22 transmit both the wavelength bands of the excitation light and the fluorescent light. The number of divided dichroic coat regions 21, the sizes thereof, and the arrangement thereof are determined in accordance with the number of incident spots 25 (black) of the excitation lights 10 from the excitation light source 5, the shapes thereof, and the positions thereof. Thus, all the excitation lights 10 from the excitation light source 5 travels toward the phosphor wheel 1.

On the other hand, the fluorescent lights and the diffused excitation lights generated by the phosphor wheel 1 are enlarged into spots 26 (broken lines) and incident on the incident surface of the mirror 4a. Of the fluorescent lights and the diffused excitation lights, all the fluorescent lights in the spots 26 are transmitted through the mirror 4 to serve as illumination light. Some of the diffused excitation lights being incident on the dichroic coat regions 21 cannot be transmitted through the dichroic coat region 21 to cause an optical loss of illumination light. However, most of the diffused excitation lights being incident on the large-area wide-wavelength transmission region 22 are transmitted through the wide-wavelength transmission region 22 to serve as illumination light.

In FIG. 2B, at a central portion of the incident surface of a mirror 4b, a rectangular (square) dichroic coat region 21 (hatched portion) is formed, and the remaining portion is used as the wide-wavelength transmission region 22 (white). In this case, the incident spots 25 (black) of the excitation lights 10 from the excitation light source 5 are small, and all the spots 25 can be confined in one dichroic coat region 21. Since the area of the dichroic coat region 21 can be made smaller than that in FIG. 2A, an optical loss of illumination light caused by the dichroic coat region 21 further decreases.

The optical loss of illumination light in the dichroic coat region 21 depends on the area of the dichroic coat region 21. According to a simulation, the area of the dichroic coat 21 is reduced to, for example, 3% or less of the area of the incident spots 26 to make it possible to suppress the optical loss to an optical loss almost equal to that in PTL1 1.

In this manner, in each of the mirrors 4a and 4b according to the embodiment, the dichroic coat regions 21 are selectively formed in the wide-wavelength transmission region 22 to make it possible to reflect the excitation lights 10 from the excitation light source 5 to guide the excitation lights 10 to the phosphor wheel 1 and to make it possible to transmit the diffused excitation lights from the phosphor wheel 1 to use the diffused excitation lights as illumination light.

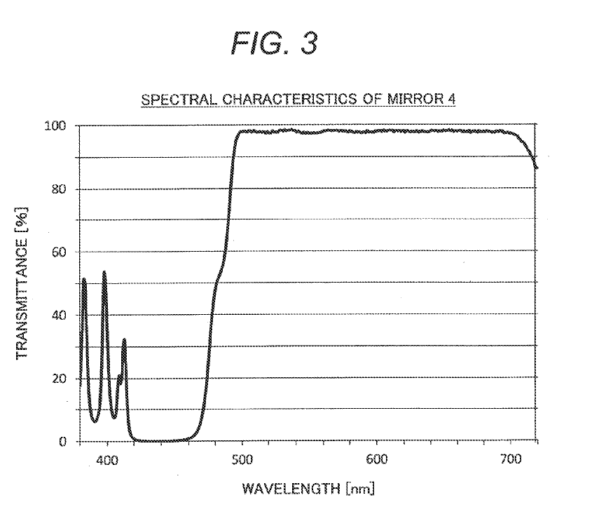

FIG. 3 is a diagram showing an example of the spectral characteristics of the mirror 4 in which the abscissa and the ordinate represent a wavelength and a transmittance, respectively. In the dichroic coat regions 21, a wavelength band (about 420 to 470 nm) of blue are not transmitted, and wavelength bands (red, yellow, and green) higher than the wavelength band of blue are transmitted. The spectral characteristics described above can be achieved by using a dielectric multilayer film (TiO₂, SiO₂, and the like).

FIG. 4 is a diagram showing a concrete example of the phosphor wheel 1. The phosphor wheel 1 is circumferentially divided into, for example, 4 segments. A red phosphor 31, a yellow phosphor 32, and a green phosphor 33 are coated on the segments as the phosphors 2, and the remaining segment is made a diffusion/reflection portion 34 obtained by giving a diffusion function to a reflecting mirror. The phosphors 31, 32, and 33 receive the excitation lights 10 to generate red, yellow, and green fluorescent lights, respectively. The diffusion function of the diffusion/reflection portion 34 can be obtained such that the base material of the phosphor wheel 1 is made specular by silver deposition or the like and a refractory transmittance/diffusion plate is stuck on the reflecting surface, or a diffusion material (paste or the like) is coated on the reflecting surface. In this case, since the diffusion plate (diffusion material) serves as an optical path through which excitation light reciprocates twice, in consideration of this, the degree of diffusion is preferably determined. Alternatively, the surface of the reflecting surface itself may be finely unleveled to give a function of reflecting and diffusing light at once to the reflecting surface. In this manner, the reflected excitation light is diffused by the diffusion/reflection portion 34 to advantageously remove speckle noise in laser light. The phosphor wheel 1 rotates to further improve the advantage of removing speckle noise.

FIG. 5 is a diagram showing the degree of diffusion of light emitted from the phosphor wheel 1. Fluorescent lights from the phosphors 2 (31, 32, and 33) of the phosphor wheel 1 are almost uniformly omnidirectionaly generated, and reflected by the mirror surfaces formed on the rear surfaces of the phosphors. As a result, the fluorescent lights are emitted in a semi-spherical shape on the condenser lens 3. Of the fluorescent lights, lights being incident on the effective area of the condenser lens 3 reach the mirror 4, and are used as the illumination light 11.

On the other hand, the diffused excitation lights from the diffusion/reflection portion 34 of the phosphor wheel 1 are emitted in a semi-spherical shape on the condenser lens 3 side. However, the degree of diffusion (diffusion angel θ) can be adjusted by materials of the diffusion plate, processing the diffusion plate, or the like. At this time, when the diffusion angles θ of the diffused excitation lights to be emitted are made excessively large, the diffused excitation lights leak out of the effective area of the condenser lens 3 to deteriorate the efficiency of utilizing light. In contrast to this, the diffusion angles θ are made excessively small, the diffused excitation lights pass through only the central portion of the effective area of the condenser lens 3. As a result, a ratio of diffused excitation lights being incident on the dichroic coat region 21 of the mirror 4 are relatively large, and an optical loss of the diffused excitation lights serving as the illumination light increases. Thus, the diffused excitation lights from the diffusion/reflection portion 34 preferably have the diffusion angles θ which are adjusted such that the diffused excitation lights are diffused in a size almost equal to that of the effective area of the condenser lens 3 and incident on the condenser lens 3.

A combination between the colors of the excitation lights and the colors of the phosphors, the number of segments, and the shapes (angles) of the segments are not limited to those in the above example, and may be arbitrarily changed depending on the specifications of required illumination light. For example, a yellow phosphor can be removed from the phosphor wheel while blue laser light is generated from the excitation light source to generate red and green fluorescent lights, or phosphors of other colors such as cyan and magenta can also be added to the above phosphors.

### Second Embodiment

A second embodiment describes that a positional relationship between the phosphor wheel 1 and the excitation light source 5 is changed.

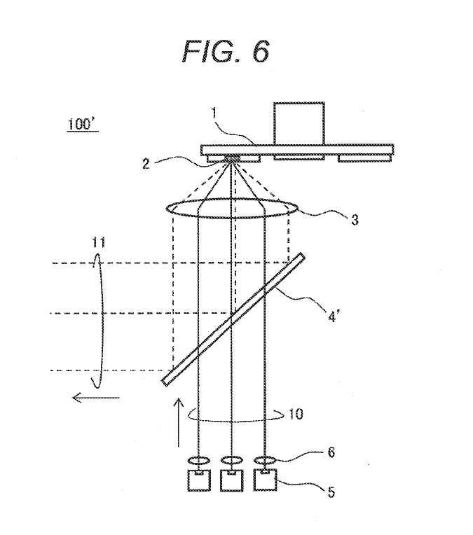

FIG. 6 is a block diagram of a light source device according to the second embodiment. The basic configuration of a light source device 100′ is the same as that in the first embodiment (FIG. 1) except that the excitation light source 5 is arranged in a lower part of the drawing, a mirror 4′ obtained by inverting the transmission/reflection characteristics of the mirror 4 is used, and illumination light is emitted to the left in the drawing. More specifically, although the mirror 4′ has the configuration shown in FIGS. 2A and 2B, the dichroic coat region 21 is characterized by transmission of a wavelength band of excitation light (blue) and reflection of wavelength bands (red, yellow, and green) of fluorescent lights. A wide-wavelength reflection region 22 is characterized by reflection of both wavelength bands of excitation light and fluorescent light. In the dichroic coat region 21, the ordinate of the spectral characteristics shown in FIG. 3 is inverted, i.e., the transmittance on the ordinate is replaced with a reflectance.

The excitation lights 10 being incident from the excitation light source 5 are transmitted through the dichroic coat region 21 of the mirror 4′, collected by the condenser lens 3, and incident on the phosphor wheel 1. When the phosphor wheel 1 receives the excitation lights 10, the phosphors 2 of the phosphor wheel 1 generate fluorescent lights of three colors, i.e., red, yellow, and green, and diffused excitation lights are generated from the diffusion/reflection portion. The fluorescent lights and the diffused excitation lights are converted into nearly parallel light rays with the condenser lens 3, and the nearly parallel light rays are incident on the mirror 4′.

The fluorescent lights being incident on the mirror 4′ are reflected both the regions, i.e., the dichroic coat region 21 and the wide-wavelength transmission region 22 in the mirror 4′. On the other hand, the diffused excitation lights being incident on the mirror 4′ are transmitted through the dichroic coat region 21, but reflected by a wide-wavelength reflection region 42. As a result, all the fluorescent lights and most of the diffused excitation lights are emitted to the left in the drawing as the illumination light 11.

With this configuration, both the fluorescent lights and the diffused excitation lights generated by the phosphor wheel 1 are emitted from the phosphor wheel 1 to the same side (lower side in the drawing), and most of the fluorescent lights and the diffused excitation lights are transmitted through the mirror 4′ and serve as illumination light. Thus, an additional optical system to combine both the fluorescent light and the excitation light need not be disposed, and a reduction in size of the device can be achieved.

Optical axis adjustment in the first and second embodiments is described here. In the light source device according to each of the embodiments, excitation light emitted from the excitation light source 5 must be reflected by a predetermined region (dichroic coat region 21) of the mirror 4 and collected on a specific position (phosphor 2) of the phosphor wheel 1. Thus, a mechanism for adjusting an error caused by misalignment of an emission position and an emission direction, resulting from the excitation light source 5, is disposed.

When the excitation light source 5 and the collimate lens 6 make an integrated structure, with respect to misalignment of the emission position and the emission direction, adjustment is performed such that the excitation light source 5 and the collimate lens 6 are integrally moved in a direction perpendicular to the optical axis. When the excitation light source 5 and the collimate lens 6 are formed as independent structures, respectively, with respect to misalignment of the emission position and the emission direction, adjustment is performed such that only the collimate lens 6 is moved in a direction perpendicular to the optical axis. With the adjusting mechanism, excitation light emitted from the excitation light source 5 can be reliably collected on a specific position of the phosphor wheel 1 through the mirror 4, and an illumination light intensity can be prevented from being decreased.

### Third Embodiment

In a third embodiment, an example in which the light source device according to each of the embodiments is applied to a projection type video display device will be described.

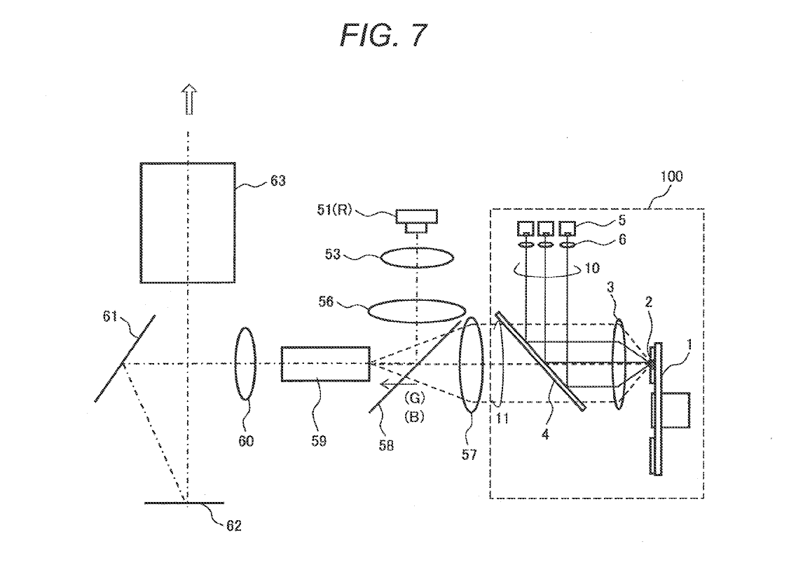

FIG. 7 is a block diagram of an optical system of the projection type video display device in the third embodiment. In this drawing, a portion corresponding to the light source device 100 has the same configuration as that in the first embodiment (FIG. 1), and a description thereof will not be given.

The illumination lights (fluorescent light and diffused excitation light) 11 transmitted through the mirror 4 in the light source device 100 are collected by a condenser lens 57 and then incident on a dichroic mirror 58. The dichroic mirror 58 is characterized by transmission of green light (to be referred to as G light hereinafter) and blue light (to be referred to as B light hereinafter) and reflection of red light (to be referred to as R light hereinafter). Thus, the G light and the B light are transmitted through the dichroic mirror 58 and incident on a multiple reflection element 59. In this embodiment, in order to compensate for a luminous flux of the R light, a red light source 51 is disposed. The R light emitted from the red light source 51 becomes nearly parallel light in a collimate lens 53, collected by a condenser lens 56, reflected by the dichroic mirror 58, and incident on the multiple reflection element 59.

The R light, the G light, and B light being incident on the multiple reflection element 59 are reflected in the multiple reflection element 59 twice or more to obtain light having a uniform illuminance distribution. The R light, the G light, and the B light emitted from an emission aperture of the multiple reflection element 59 are transmitted through a condenser lens 60, reflected by a reflection mirror 61, and irradiated on a video display element 62 at a uniform illuminance distribution.

The video display element 62 employs a system which uses, for example, a digital mirror device (DMD named by Texas Installments) and time-divisionally irradiates the R light, the G light, and the B light thereon. The excitation light source 5 and the red light source 51 are solid-state light-emitting elements having high response speeds, and can be time-divisionally controlled. Thus, each of the color lights are time-divisionally modulated in units of colors by the video display element 62. The color lights reflected by the video display element 62 serve as video lights, and the video lights are incident on a projection lens 63, and projected on a screen (not shown).

The brightness of a specific color is secured by using the red light source 51 besides light source device 100 here. However, a configuration which uses only the light source device 100 without using the red light source 51 can also be effected. In this case, the dichroic mirror 58 may be removed, color lights emitted from the phosphor wheel 1 may be used, and the video display element 62 may be operated in synchronism with the color lights. Furthermore, the light source device 100′ according to the second embodiment (FIG. 5) may be used in place of the light source device 100, as a matter of course.

The projection type video display device according to the embodiment uses a compact light source device which has a small size and a small optical loss of illumination light to contribute to a reduction in size and improvement in performance of the projection type video display device.

### Fourth Embodiment

A fourth embodiment is another example of the projection type video display device and has a configuration using liquid crystal panels corresponding to three colors (R, G, and B) as a video display element.

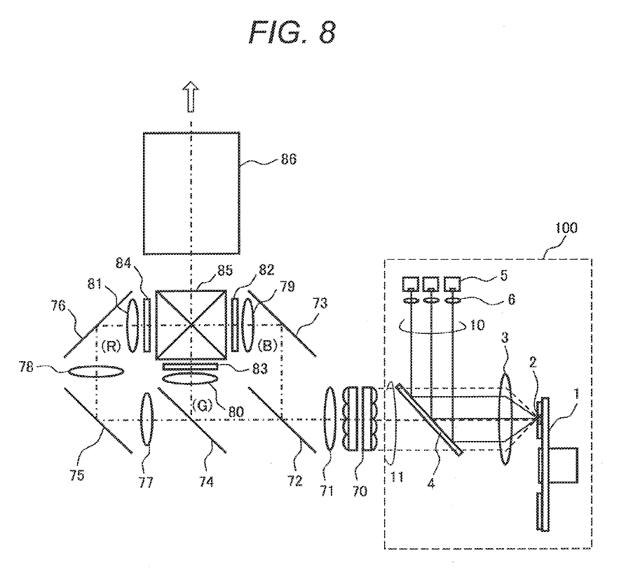

FIG. 8 is a block diagram of an optical system of the projection type video display device according to the fourth embodiment. In the drawing, a portion corresponding to the light source device 100 has the same configuration as that in the first embodiment (FIG. 1), and a description thereof will not be given. The illumination light (fluorescent light and diffused excitation light) 11 transmitted through the mirror 4 of the light source device 100 is changed into uniform illumination light by a fly-eye lens 70, and the illumination light is transmitted through a lens 71 and travels to a color separation optical system.

The color separation optical system separates illumination light emitted from the light source device 100 into R light, G light, and B light, and guides the R light, the G light, and the B light to the liquid crystal panels corresponding to the color lights, respectively. The B light is reflected by the dichroic mirror 72 and incident on a B-light liquid crystal panel 82 through a reflection mirror 73 and a field lens 79. The G light and the R light are transmitted through the dichroic mirror 72 and then separated by a dichroic mirror 74. The G light is reflected by the dichroic mirror 74, transmitted through a field lens 80, and incident on a G-light liquid crystal panel 83. The R light is transmitted through the dichroic mirror 74 and incident on an R-light liquid crystal panel 84 through relay lenses 77 and 78, reflection mirrors 75 and 76, and a field lens 81.

The liquid crystal panels 82, 83, and 84 modulate the incident color lights depending on video signals, respectively, to form optical images of the color lights. The optical images of the color lights are incident on a color combining prism 85. In the color combining prism 85, a dichroic film which reflects the B light and a dichroic film which reflects the R light are formed in an nearly X shape. The B light and the R light being incident from the liquid crystal panels 82 and 84 are reflected by the B-light dichroic film and the R-light dichroic film, respectively. The G light being incident from the liquid crystal panel 83 is transmitted through the dichroic films. As a result, the optical images of the color lights are combined to each other and emitted as color video light. The combined light emitted from the color combining prism 85 is incident on the projection lens 86 and projected on a screen (not shown).

Also in the projection type video display device according to the embodiment, a compact light source device having a small size and a small optical loss of illumination light is used to contribute to a reduction in size and improvement in performance of the projection type video display device.

### REFERENCE SIGNS LIST

1 . . . phosphor wheel
2 . . . phosphor
3 . . . condenser lens
4 . . . mirror
5 . . . excitation light source
6 . . . collimate lens
10 . . . excitation light
11 . . . illumination light (fluorescent light and diffused excitation light)
21 . . . dichroic coat region (first region)
22 . . . wide-wavelength transmission region (second region)
100 . . . light source device.

1. The light source device comprising:
an excitation light source which generates excitation light;
a phosphor wheel having a phosphor which is excited by the excitation light from the excitation light source to generate fluorescent light; and
a mirror which guides the excitation light from the excitation light source to the phosphor wheel and emits the fluorescent light from the phosphor wheel as illumination light, wherein
the phosphor wheel further includes a diffusion/reflection portion which diffuses and reflects incident excitation light, and
the mirror has a first region which reflects the excitation light and transmits the fluorescent light and a second region which transmits the fluorescent light and the diffused excitation light diffused and reflected by the diffusion/reflection portion.

2. The light source device according to claim 1, wherein
the fluorescent light transmitted through the first region, the fluorescent light transmitted through the second region, and the diffused excitation light transmitted through the second region are emitted as illumination light.

3. A light source device comprising:
an excitation light source which generates excitation light;
a phosphor wheel having a phosphor which is excited by the excitation light from the excitation light source to generate fluorescent light; and
a mirror which guides the excitation light from the excitation light source to the phosphor wheel and emits the fluorescent light from the phosphor wheel as illumination light, wherein
the phosphor wheel further includes a diffusion/reflection portion which diffuses and reflects incident excitation light, and
the mirror has a first region which transmits the excitation light and reflects the fluorescent light and a second region which reflects the fluorescent light and the diffused excitation light diffused and reflected by the diffusion/reflection portion.

4. The light source device according to claim 3, wherein
the fluorescent light reflected by the first region, the fluorescent light reflected by the second region, and the diffused excitation light reflected by the second region are emitted as illumination light.

5. The light source device according to claim 1, wherein
the first region is formed to include a position on which the excitation light from the excitation light source is incident and which has an area smaller than that of the second region.

6. The light source device according to claim 5, wherein
the excitation light source includes a plurality of light sources, and
the first region corresponds to each position on which each excitation light from each of the plurality of light sources is incident, and is divisionally formed in a plurality of regions.

7. The light source device according claim 1, wherein
the diffusion/reflection portion is formed by sticking a diffusion plate on a reflecting surface, coating a diffusion material on a reflecting surface, or finely unleveling a surface of a reflecting surface itself.

8. The light source device according to claim 7, wherein
a condenser lens is disposed between the phosphor wheel and the mirror, and
the excitation light diffused and reflected by the diffusion/reflection portion is diffused in a size almost equal to that of an effective area of the condenser lens, and incident on the condenser lens.

9. The light source device according claim 1, wherein
the excitation light source generates blue laser light as excitation light, and
the phosphor wheel has phosphors which generate red, yellow, and green lights, respectively.

10. The light source device according claim 1, wherein
a collimate lens is disposed between the excitation light source and the mirror,
when the excitation light source and the collimate lens make an integrated structure, in order to adjust misalignment of an emission position and an emission direction of the excitation light from the excitation light source, an adjusting mechanism which integrally moves the excitation light source and the collimate lens in a direction perpendicular to an optical axis is disposed, and
when the excitation light source and the collimate lens are formed as independent structures, respectively, in order to adjust misalignment of the emission position and the emission direction of the excitation light from the excitation light source, an adjusting mechanism which moves the collimate lens in a direction perpendicular to the optical axis is disposed.
